(19) United States
(12) Patent Application Publication
(10) Pub. No.: US 2018/0179435 A1
(43) Pub. Date: Jun. 28, 2018

(54) NANOFIBRILLATED CELLULOSE FOR USE IN FLUIDS FOR ENHANCED OIL RECOVERY

(71) Applicant: ELKEM AS, Oslo (NO)

(72) Inventor: Mohamed AL-BAGOURY, Kristiansand S (NO)

(21) Appl. No.: 15/577,090

(22) PCT Filed: May 27, 2016
(86) PCT No.: PCT/NO2016/050108

§ 371 Date: Nov. 27, 2017

(30) Foreign Application Priority Data
May 29, 2015 (NO) 20150689

(51) Int. Cl. C09K 8/58

(52) U.S. Cl. CPC C09K 8/58; C09K 2208/10; C09K 2208/08

(57) ABSTRACT

The present invention relates to nanofibrillated cellulose (NFC) for use as viscosity modifier in fluids for enhanced oil recovery. The fluids contain NFC with an aspect ratio of less than 1000 where the nanofibrils have a diameter between 5 and 50 nanometer and a length of less than 10 μm.

### TECHNICAL FIELD

The present invention is directed towards the use of nanofibrillated cellulose (NFC) in fluids used for enhanced oil recovery (EOR).

### BACKGROUND ART

Macromolecules (polymeric materials), in particular the water-soluble ones, are among the most used chemicals for the extraction of hydrocarbons from subterranean formations. Whether the extraction is primary or tertiary extraction, polymers are used for various functions. For example, in oil and gas well drilling, polymers are used as viscosity modifier, dispersants, or for filtration control purposes. In the case of well stimulation, either by acidizing or hydraulic fracturing, polymers are also used as viscosity modifier and as filtration control additive. In tertiary recovery called enhanced oil recovery, (EOR), polymers, mainly polyacrylamide, are used as permeability modifiers and viscosifier. Hence, polymers are extensively used additives for oilfield fluids but they should be carefully selected to avoid any negative impact on the oil recovery. Polymers like polyacrylamide further have a negative influence on the environment.

Polymers used in oil extraction are either bio-based or fossil-based materials. Generally, biopolymers is used at low to medium temperature<150° C. Synthetic polymers are used in wider temperature ranges due to their high thermal stability.

Nano-fibrillated cellulose (NFC) is a new class of materials produced from renewable resource and it has a potential as useful additive for oilfield applications. There is great focus to use renewable resources to replace chemicals from petrochemical industry to reduce the carbon footprint. In WO 2014148917 the use of the NFC or micro-fibrillated cellulose (MFC) as viscosifier for oilfield fluids such as fracturing, drilling fluid, spacer fluids and EOR fluids is disclosed. Fluids viscosified with NFC show excellent shear-thinning properties and this is due to the high aspect ratio of the nano-fibrils>100. The aspect ratio of fibril is length divided by diameter of fibril (length/diameter). Additionally, NFC is more thermally stable compared to natural polymers such as xanthan and guar gums, cellulose and starch derivatives, etc. Furthermore, depending on its surface charge, it has high tolerance to salts compared to commercially available biopolymers or synthetic polymers.

NFC can be produced by various processes from any cellulose- or lignocellulose-containing raw materials and its characteristics can be tailor-made. Most of research on NFC is focused on the use of bleached pulp as feedstock to prepare NFC. However, is economically favorable to use lignocellulosic biomass instead of purified pulp as a feedstock to produce nano-fibrillated lignocellulose, (NFLC). The sources of lignocellulosic biomass are many, such as wood, straw, agricultural waste such as bagasse and beet pulp, etc. This is only applicable, if the end application tolerates the presence of lignin in the final product.

Plant cell wall is composed mainly of lignocellulosic biomass, which consists of cellulose, hemicellulose and lignin. The ratio of these three main components and their structural complexity vary significantly according to the type of plants. In general, cellulose is the largest component in the plant cell wall and it is in the range 35-50% by weight of dry matter, hemicellulose ranges from 15-30% and lignin from 10-30%. As other macromolecules used in oilfield application, the removal of NFLC after the use is desirable. Fortunately, two possible solutions are existing to remove or degrade NFLC by means of enzymatic or oxidative degradation. The enzymatic degradation of lignocellulosic biomass is intensively researched, since it is the main step in biofuel production from biomass. Recent developments achieved a considerable reduction to the overall cost of the enzymatic degradation by optimization the enzyme efficiency, find the best enzymes combination to the targeted biomass, the pretreatment of the biomass to be easily accessible by the enzyme and find the optimal degradation conditions.

NFC or NFLC with wide range of physicochemical properties can be produced, by either selecting the raw materials, or by adjusting the production parameters, or by a post-treatment to the produced fibrils. For example, the dimension of the NFC fibril can be varied to fit for the propose of application. Generally, the diameter of cellulose fiber, that composed of bundles of fibrils, in plants is in the range 20-40 μm, with a length in the range of 0.5-4 mm. A single cellulose fibril, which can be obtained by a complete defibrillation of the cellulose fiber, has a diameter of a few nanometers, around 3 nm, and a length of 1-100 μm. Depending on the energy input for the defibrillation and the pretreatment prior the defibrillation, the diameter of the fiber can be reduced to an order of magnitude of nanometers (5-500 nm). In addition, the fibril length can be controlled to a certain degree to make it suitable for the desired application. Also, it is well-know from literature that cellulose molecules can be chemically modified in various ways to obtain the desired chemistry. The surface chemistry of NFC in the same way can be tailored to meet the end use needs. Normally, the surface charge of cellulose molecules is neutral with hydroxyl groups on the surface, but the hydroxyl groups are convertible to anionic or cationic charges. The etherification and esterification are among the most used methods to alter the cellulose surface properties.

The nature of NFC allows tailor making its physicochemical properties to match the use in oilfield fluids. Both the fibrils morphology and fibrils' chemistry are adjustable to fit the application requirements.

The thermal stability of NFLC having a high lignin content is not satisfactory. However, NFLC containing up to 25 wt % lignin based on dry matter has an acceptable thermal stability for use in EOR fluids.

Core flooding test is a commonly used method to study the flow of fluid into a porous medium. This test method provide useful information about the interaction of fluids and their components with a core sample representing the target reservoir. This technique is used to assess the formation damage potential of a fluid to oil/gas reservoirs as well to evaluate the penetrability of polymers into a reservoir as in the case of EOR application. The test conditions such as temperature pressure, fluid compositions, core type, and flow rate are set normally to simulate the oilfield and application conditions.

It is an object of the present invention to provide nanofibrillated cellulose for use as an additive in fluids for enhanced oil recovery where the NFC are able to penetrate into the formation.

### Short Description of the Invention

The present invention relates to the nanofibrillated cellulose (NFC) for use in fluids for enhanced oil recovery, wherein the fluids contain NFC with an aspect ratio of less than 1000 where the nanofibrils have a diameter between 5 and 50 nanometer and a length of less than 10 μm.

According to a preferred embodiment NFC has an aspect ratio of less than 500, where the nanofibrils have a diameter between 5 and 30 nanometer and a length of less than 5 μm.

According to another preferred embodiment, the nanofibrillated cellulose is nanofibrillated lignocellulose containing up to 25 wt % lignin based on dry matter and preferably up to 10 wt % lignin based on dry matter.

According to another preferred embodiment, the nanofibrillated cellulose has a surface charge (carboxyl group) concentration in the range from 0.1 to 1 mmol per gram of NFC and preferably less than 0.5 mmol per gram of NFC.

In enhanced oil recovery (tertiary recovery), one of the common techniques to enhance the recovery is called polymer flooding. Typically high molecular weight partially hydrolyzed polyacrylamide (PHPA) is used in concentration range of a few 100 ppm to increase the water viscosity to improve the sweep efficiency. The typical reservoir permeability for EOR polymer flooding is >100 mD. The penetration of standard NFC into high permeability core is not high. A part of the fibrils are filtered out on the core surface and some fibrils are entrapped in the core matrix and are clogging the pores in the core. To overcome this injectivity issue it has been found that the use of short-length fibrils drastically improves the injectivity.

The fibrils dimension can be controlled as follows; 1) The diameter becomes finer and finer by increasing the defibrillation energy used and by using a pretreatment step prior to the defibrillation, to facilitate the defibrillation process. The thinnest fibril diameter is just a few nanometers. 2) The length of the fibrils is rather difficult to control; however, intense chemical or enzymatic pretreatments lead to shortening the fibril length significantly. Under drastic chemical oxidative conditions such as periodate, followed by chlorite oxidation, the fibril length can be reduced to just 100 nm as described in the WO 2012119229. According to WO 2012119229 the surface charge (carboxyl group) concentration of NFC can range from 0.1 to 11 mmol per gram of NFC and an aspect ratio in a range from less than 10 to more than 1,000 can be obtained.

Anikó Várnai described the enzymatic degradation of high solid-content lignocellulosic substrates in his PhD 2012, “Improving enzymatic conversion of lignocellulose to platform sugars” at University of Helsinki, Department of Food and Environmental Sciences, VTT Technical Research Centre of Finland, Biotechnology. This can be a useful method to produce high concentration of short NFC for use in EOR application.

The chemical method reduces the fibril length, but at the same time increases the anionic charge density of the fibril, due to the oxidation of the secondary & primary hydroxyl groups of the glucose unit. The enzymatic treatment also reduces the length without having a significant effect on the surface charge. The carboxylate content of NFC produced by enzymatic pretreatment is less than 200 μmol/g NFC.

### Further Description of the Invention

The NFC materials used in the examples below were produced in the laboratory as described in the literature as follows.
1) TEMPO mediated NFC (TEMPO-NFC) was produced according to the publication of Saito et al. (Saito, T. Nishiyama, Y. Putaux, J. L. Vignon M. and Isogai. A. (2006). Biomacromolecules, 7(6): 1687-1691). TEMPO is 2,2,6,6-tetramethylpiperidine-1-oxyl radical. Generally, TEMPO-NFC has a diameter less than 15 nm and has a charge density in the range 0.2-5 mmol/g.
2) Enzymatic assisted NFC (EN-NFC) was produced according to the publication of Henriksson et al, European polymer journal (2007), 43: 3434-3441 (An environmentally friendly method for enzyme-assisted preparation of microfibrillated cellulose (MFC) nanofibers) and M. Paakko et al. Biomacromolecules, 2007, 8 (6), pp 1934-1941, Enzymatic Hydrolysis Combined with Mechanical Shearing and High-Pressure Homogenization for Nanoscale Cellulose Fibrils and Strong Gels. ME-NFC has a diameter less than 50 nm and has a charge density of <0.2 mmol/g.
3) Mechanically produced MFC (NE-NFC) was produced as described by Turbak A, et al. (1983) “Microfibrillated cellulose: a new cellulose product: properties, uses, and commercial potential”. J Appl Polym Sci Appl Polym Symp 37:815-827. ME-MFC can also be produced by one of the following methods: homogenization, microfluidization, microgrinding, and cryocrushing. Further information about these methods can be found in paper of Spence et al. in Cellulose (2011) 18:1097-1111, “A comparative study of energy consumption and physical properties of microfibrillated cellulose produced by different processing methods”. ME-NFC has a diameter less ca. 50 nm and has a charge density (carboxylate content) of <0.2 mmol/g.
4) Carboxymethylated NFC (CM-NFC) was produced according to the method set out in “The build-up of polyelectrolyte multilayers of microfibrillated cellulose and cationic polyelectrolytes” Wågberg L, Decher G, Norgen M, Lindström T, Ankerfors M, Axnäs K Langmuir (2008) 24(3), 784-795. CM-NFC has a diameter less than 30 nm and has a charge density in the range 0.5-2.0 mmol/g.

The equipment used to measure the various properties of the produced NFC included a mass balance, a constant speed mixer up to 12000 rpm, a pH meter, a Fann 35 viscometer, a Physica Rheometer MCR—Anton Paar with Couette geometry CC27, and a heat aging oven (up to 260° C. at pressure of 100-1000 psi) and a core flooding system.

### SHORT DESCRIPTION OF DRAWINGS

FIG. 1 is a diagram showing viscosity of NFC as function of shear rate after degradations with sodium bromate,

FIG. 2 is a diagram showing viscosity of NFC as function of shear rate after degradations with sodium persulfate, and,

FIG. 3 is a diagram showing viscosity of NFC as function of shear rate after degradations with cellulase enzyme.

### EXAMPLE 1

### Effect of Chemical and Enzymatic Degradation of NFC

Below are examples on how to reduce the fibril length of NFC by chemical and enzymatic means.

A) Chemical Degradation with Sodium Bromate

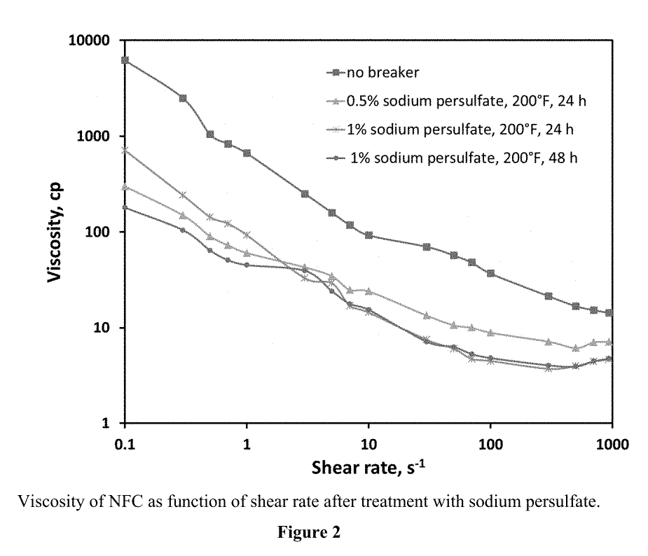

NFC concentrate was diluted with 5% KCl to make a fluid with NFC concentration of 0.48 wt.-%. Sodium bromate was added to make 1 wt.-% and treated at 300° F. for 16 hours. As shown in FIG. 2, after 8 hours the viscosity was still high. However, after 16 h, the viscosity decreased to very low values, suggesting that the fibers were successfully degraded under such conditions. Extended heating time beyond 16 hours did not help reducing the viscosity further.

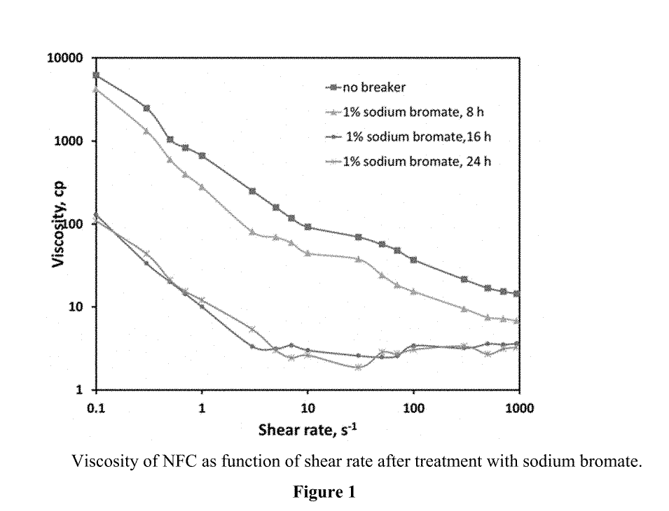

FIG. 1 illustrates the decline in viscosity as function of time for NFC dispersion treated with sodium bromate as an oxidizer. The result in FIG. 1 indicates that 16 hours treatment with 1% sodium bromide reduces the aspect ratio of the fibrils to well below 1000.
B) Chemical Degradation with Sodium Persulfate

NFC with a concentration of 0.48 wt % was treated with 0.5 wt % sodium persulfate for 24 hours and with 1 wt % sodiumpersulfate at 24 hours and 48 hours respectively.

FIG. 2 illustrates the decline in viscosity as function of time for NFC dispersion treated with sodium persulfate as an oxidizer. The result in FIG. 1 indicates very good results are obtained for 24 hours treatment with both 0.5 and 1 wt % sodium persulfate. FIG. 2 further shows that increasing the treatment time to 48 hours does not result in a further decrease in viscosity. Treatment with sodium persulfate thus reduces the aspect ratio of the fibrils to well below 1000.

C) Enzymatic Degradation

In this example, the fibril length was shortened using a cellulase enzyme at 50° C. for 24 hours. A 0.6 wt % NFC dispersion in distilled water was prepared. A cellulase enzyme, Celluclast® 1.5 L from Novozymes, was added to degrade the fibrils. The viscosity of the fibril dispersion was monitored over time. When the viscosity reach a value of 20 mPa·s at shear rate of 1/s, the reaction was stopped by the enzyme denaturation at high temperature of 120° C. The degradation time depends on enzyme/fiber ratio. The higher the ratio is, the shorter the degradation time will be.

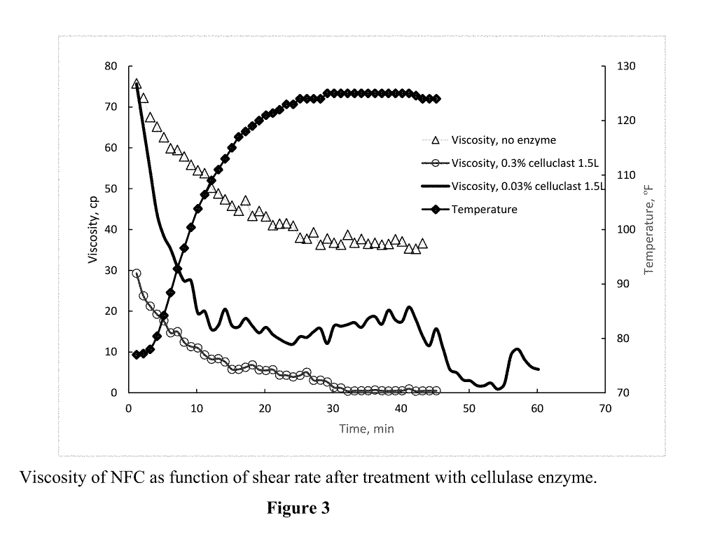

The size reduction was monitored indirectly using viscosity measurements. As shown in FIG. 3, the viscosity decreased as a function of time, indicating the reduction in the fibril length and concurrently the aspect ratio. Light scattering method and scanning electron microscope were used to see the effect of the degradation on the fiber morphology. There is a clear indication for shorten the fiber length.

### EXAMPLE 2

### Core Flooding Tests

Core flooding tests on NFC fluids were performed using different types of cores, both sandstone and limestone, under different conditions such as various NFC concentrations, various types of NFC, at various temperatures, flow rate and different pressures.

The procedure used for the core flooding tests was as follows:

1. The core was dried at 250° F. for 4 hours and weighed to obtain its dry weight. Then the core was saturated with brine solution (5 wt % KCl in deionized water) for 6 hours under vacuum and its wet weight was measured. The pore volume (PV) was calculated using these measurements and the density of the brine solution (density=1.03 g/cm3 at 70° F.).

2. The core was placed inside a core holder. The brine (5 wt % KCl) was pumped through the core in the production direction. If elevated temperature was required, the temperature was raised to the target value (250° F.) and kept constant during the test. The pressure drop across the core was monitored and recorded until it was stabilized. The initial permeability was calculated.

3. The treatment fluid was prepared by diluting 1.0 wt % NFC dispersion with 5 wt % KCl brine to NFC concentration of 0.1 wt % (1000 ppm). A 100 g NFC solution was mixed into 600 g KCl brine (5 wt %) to make the 0.01 wt % NFC as a treatment fluid.

4. The treatment fluid containing NFC and/or other chemicals was pumped, in the injection direction (reversed to production direction), at the back pressure of 1100 psi. The pressure drop across the core increased as the fiber fluid was injected. The injection was stopped when 2 PV was injected. The pressure drop across the core was recorded.

5. The direction of flow was then reversed to the production direction and the brine (5 wt % KCl) was injected into the core until the pressure drop across the core was stabilized. The return permeability after fluid treatment was calculated.

The enzymatic degraded NFC produced in Example 1 was injected in 400 mD carbonate core. For comparison purposes, untreated NFC was injected into another 400 mD carbonate core.

As shown in Table 1, the return permeability increased after the enzymatic treatment from 66 to 93%. The core surface was clean and there were no fibrils filtered out on the core surface at the injection phase. NFC with long fibrils with length of more than 10 μm do not penetrate the core samples. This indicates that by shortening the fibril length, the injectivity of the NFC fibril into porous medium, has improved and that short-length NFC can be used as viscosity modifier for water flooding. In addition, it was observed that short fibrils with low surface charge such as ME-NFC or EN-NFC penetrate better than short fibrils with high surface charge such as TEMPO-NFC and CM-NFC.

TABLE 1
Core flooding of NFC before and after enzymatic degradation
using 400 mD carbonate core at temperature of 250 F. °.

| | Test 1 | | Test 2 | |
|---|---|---|---|---|
| | Original fibril | | Degraded fibril | |
| | Pressure | Permeability | Pressure | Permeability |
| | drop (psi) | (mD) | drop (psi) | (mD) |
| Initial | 9.4 | 348.4 | 10.2 | 321.1 |
| permeability | | | | |
| Final | 14.2 | 230.7 | 11.0 | 297.8 |
| permeability | | | | |

| | | |
|---|---|---|
| Return | 66 | 93 |
| permeability (%) | | |

The chemical degraded NFC produced with treatment with sodium borate in Example 1 was injected in 400 mD carbonate core. For comparison purposes untreated NFC was injected into another 400 mD carbonate core.

As shown in Table 2, the return permeability increased after the chemical treatment from 18 to 93%. The core surface was clean and there were no fibrils filtered out on the core surface at the injection phase. This indicates that by shortening the fibril length, the injectivity of the NFC fibril into porous medium core, has improved and that short-length NFC can be used as viscosifier for water flooding.

TABLE 2
Core flooding of CM-NFC before and after chemical degradation,
using 400 mD carbonate core at temperature of 250 F. °.

| | Tests 3 | | Test 4 | |
|---|---|---|---|---|
| | Original fibril | | Degraded fibril | |
| | Pressure | Permeability | Pressure | Permeability |
| | drop (psi) | (mD) | drop (psi) | (mDAbs) |
| Initial | 7.8 | 420 | 7.9 | 415 |
| permeability | | | | |
| Final | 43.0 | 76 | 8.5 | 385 |
| permeability | | | | |

| | | |
|---|---|---|
| Return | 18 | 93 |
| permeability (%) | | |

1-6. (canceled)

7. A fluid for use in enhanced oil recovery, wherein the fluid contains, as viscosity modifier, nanofibrillated cellulose (NFC) with an aspect ratio of less than 1000 where the nanofibrils have a diameter between 5 and 50 nanometer and a length of less than 10 μm, wherein the NFC has a surface charge of carboxyl groups in a concentration of less than 0.5 mmol per gram of NFC.

8. A fluid as claimed in claim 7, wherein the aspect ratio of NFC is less than 500 where the nanofibrils have a diameter between 5 and 30 nanometer and a length of less than 5 μm.

9. A fluid as claimed in claim 7, wherein the NFC is nanofibrillated lignocellulose having a lignin content of up to 25 wt % based on dry matter.

10. A fluid as claimed in claim 9, wherein the NFC is nanofibrillated lignocellulose having a lignin content of up to 10 wt % based on dry matter.
